(19) United States
(12) Patent Application Publication
(10) Pub. No.: US 2024/0394085 A1
(43) Pub. Date: Nov. 28, 2024

(54) FAILURE BEHAVIOR OF STRETCHED CLUSTERS

(71) Applicant: VMware, Inc., Palo Alto, CA (US)

(72) Inventors: Cormac John Hogan, Youghal (IE); Frank Denneman, Purmerend (NL); Duncan Gerardus Cornelis Antonius Epping, Helmond (NL)

(21) Appl. No.: 18/201,098

(22) Filed: May 23, 2023

(51) Int. Cl. G06F 9/455

(52) U.S. Cl. CPC G06F 9/45558; G06F 2009/4557; G06F 2009/45591; G06F 2009/45595

(57) ABSTRACT

The disclosure provides an approach for failure behavior. Embodiments include detecting a virtual computing instance (VCI) operating on a first node in a first fault domain in a multi-fault domain storage cluster also including a second fault domain comprising a second node, and a witness fault domain comprising a witness node. Embodiments also include automatically registering the first fault domain as a preferred fault domain for the VCI. Embodiments include determining, at the second fault domain, whether a loss of communication over an inter-fault domain network link between the first fault domain and the second fault domain is due to a failure of the first fault domain or of the inter-fault domain network link. Further, embodiments include, in response to the failure of the first fault domain, restarting, on the second node, the VCI, and automatically registering the second fault domain as the preferred fault domain for the VCI.

### BACKGROUND

Distributed systems allow multiple clients in a network to access a pool of shared resources. For example, a distributed storage system, such as a distributed virtual storage area network (VSAN) datastore, allows a cluster of host computers (i.e., physical machines such as servers) to aggregate local physical disks (e.g., SSD, PCI-based flash storage, SATA, or SAS magnetic disks) located in or attached to each host computer to create a single and shared pool of storage. This pool of storage (sometimes referred to herein as a “datastore” or “store”) is accessible by all host computers in the cluster and may be presented as a single namespace of storage entities (such as a hierarchical file system namespace in the case of files, a flat namespace of unique identifiers in the case of objects, etc.). Storage clients operating on the host computers may use the datastore to store objects (e.g., virtual disks) that are accessed by virtual computing instances (VCIs), such as virtual machines (VMs), during their operations. An object is any data, structured or unstructured, and is a unit of storage of the datastore.

Each object stored in the datastore may include one or more components. A component may be a part of, or portion of, an object. In some cases, such as depending on the storage policy that is defined (e.g., by an administrator) for the object, mirrors (i.e., copies) of components of the object are stored on different hosts in the cluster. For example, a copy of a first component may be stored on both a first host and a second host of the cluster. Accordingly, should either of the first host or the second host become unavailable or inoperable, the component of the object is still available on the other of the first host or the second host, providing high availability of the object. In another example, if a storage policy for an object requires higher performance, different components of the object may be stored on different disks or hosts, such that I/O operations on the different components can occur in parallel on the different disks or hosts. For example, a first component of the object may be stored on a first disk and a second component of the object may be stored on a second disk. The different components of an object may also be referred to as “object components.”

In some cases, hosts of a cluster are distributed across multiple (e.g., at least two) fault domains (e.g., different physical sites, different portions of a network, etc.), and such a cluster is referred to as a “stretched cluster.” A fault domain is a set of hosts that share a single point of failure, such that if one host in the fault domain fails, there is a high correlation of other hosts in the same fault domain failing, but a low correlation of other hosts in other fault domains failing. A fault domain, therefore, may be defined as hosts that share the same physical location, same physical rack, same physical network, and/or other point of failure. In some cases, a fault domain may be a site, which may be a data center.

In certain cases, components of storage objects are replicated across multiple fault domains, such as to provide high availability. Such components replicated across multiple fault domains may be referred to as stretched components, and the corresponding objects may be referred to as stretched objects. For example, one or more components of a storage object may be stored on one or more hosts of a first fault domain as well as one or more hosts of a second fault domain. The stretched storage object may be associated with a VCI, such as where the stretched storage object is a virtual disk of a VCI. In some cases, a VCI accesses the copy of its storage object that resides in the fault domain where the VCI is currently running (the copy of the storage object in the same fault domain being referred to as “a site-local copy”).

### BRIEF DESCRIPTION OF THE DRAWINGS

FIG. 1 is a diagram illustrating an example computing environment in which embodiments of the present application may be practiced.

FIGS. 2A-2E illustrate operation of a stretched cluster, according to an example embodiment of the present application.

FIGS. 3 and 4 are flowcharts of example methods to manage faults in a stretched cluster, according to an example embodiment of the present application.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides improved systems and methods for failure behavior for stretched clusters.

Each VCI running in a stretched cluster may be assigned a preferred fault domain (and optionally a secondary fault domain). Accordingly, in certain cases, when there is a network connection failure, the VCI is restarted on a host in the preferred fault domain of the VCI. In certain aspects, the VCI itself is directly assigned a preferred fault domain (and optionally a secondary fault domain). In certain aspects, each object, or even each component of each object, of the VCI stored in the stretched cluster is assigned a preferred fault domain (and optionally a secondary fault domain), and by association the VCI is assigned a preferred fault domain (and optionally a secondary fault domain). In certain aspects, each object or each component of each object of the VCI is assigned the same preferred fault domain (and optionally secondary fault domain).

For example, assume a stretched cluster includes a first fault domain including a first set of hosts, and a second fault domain including a second set of hosts. Further, the first fault domain has a network connection to the second fault domain, such that the first set of hosts are connected to the second set of hosts. Further, assume that a first VCI is running on a host of the second set of hosts in the second fault domain. The preferred fault domain of the VCI is set as the first fault domain. The VCI may not be running in its preferred fault domain for a variety of reasons, such as load balancing.

In certain cases, when there is a network connection failure between the first fault domain and the second fault domain, the VCI is restarted in the preferred fault domain, meaning the VCI is restarted on a host of the first set of hosts in the first fault domain, instead of continuing to run in the second fault domain without restarting. Such restarting of the VCI may cause outage time for the VCI, which is not desirable. Such restarting may occur even when both the first set of hosts of the first fault domain and the second set of hosts of the second fault domain are able to communicate with a witness node (e.g., a physical machine or VCI) running in a third fault domain. As both the first set of hosts and the second set of hosts are able to communicate with the witness node, it is known in the system that both fault domains are running properly, and therefore it is not absolutely necessary for the VCI to be restarted in the first fault domain instead of continuing to run in the second fault domain. In particular, to manage fault domains in a stretched cluster, a witness node is established in the third fault domain, which may be referred to as a witness fault domain. The witness node facilitates failover decisions in the event of a fault domain failure or inter-fault domain network failure, as further discussed herein.

Accordingly, certain aspects herein provide techniques for automatically setting the preferred fault domain of a VCI to be the fault domain in which the VCI is currently running. Such techniques provide fault tolerance while reducing the number of circumstances in which a VCI is restarted, thereby reducing VCI outage time. In certain aspects, when a VCI is created, a witness node automatically assigns the preferred fault domain of the VCI to be the fault domain in which the VCI is operating. An administrator may specify a secondary fault domain. In some examples, when the VCI is restarted in a different fault domain (e.g., the secondary fault domain), the system automatically reassigns the different fault domain to be the preferred fault domain.

In certain aspects, each fault domain provides a heartbeat message to the witness node. The heartbeat facilities the witness node directly or indirectly providing the status of each fault domain when a decision to restart VCIs is necessary. This reduces the number of times a VCI may need to be restarted. For example, because the fault domain in which the VCI is operating is its preferred fault domain, inter-fault domain network failures alone do not necessitate the VCI being restarted. Certain aspects are further discussed herein with respect to a site as a fault domain for illustrative purposes. However, it should be understood that this is merely an example, and the techniques herein may be used with any suitable fault domain.

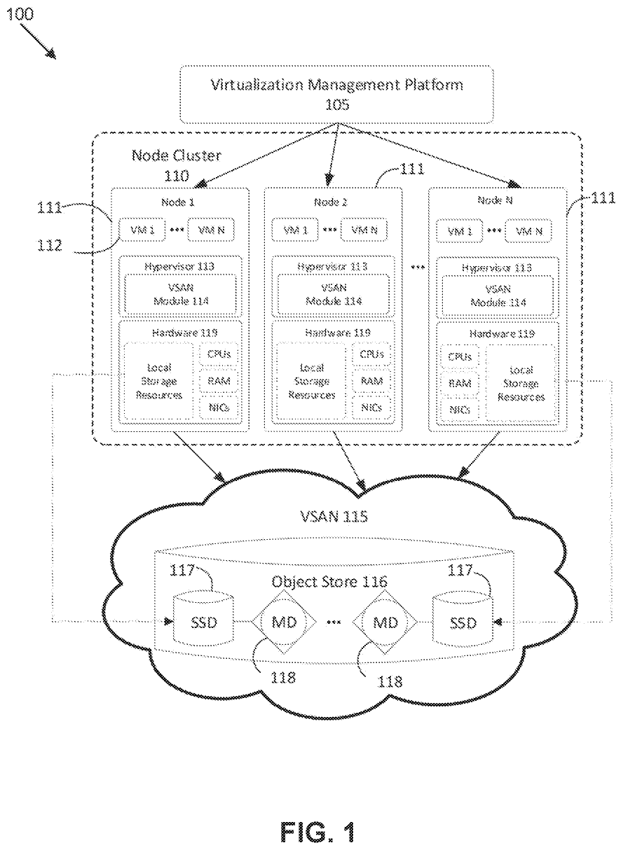

FIG. 1 illustrates an example computing environment 100 in which embodiments of the present application may be practiced. As shown, computing environment 100 includes a distributed object-based datastore, such as a software-based “virtual storage area network” (VSAN) environment that leverages the commodity local storage housed in or directly attached (hereinafter, use of the term “housed” or “housed in” may be used to encompass both housed in, or otherwise directly attached) to host machines/servers or nodes 111 of a storage cluster 110 to provide an aggregate object store 116 to virtual machines (VMs) 112 running on the nodes. The storage cluster 110 may encompass multiple sites. For example, some of nodes 111 may be located on a first site and other nodes 111 may be located on a second site. Storage cluster 110 may, for example, be a stretched cluster. The local commodity storage housed in the nodes 111 may include one or more of solid state drives (SSDs) or non-volatile memory express (NVMe) drives 117, magnetic or spinning disks or slower/cheaper SSDs 118, or other types of storages.

In the illustrated example, each node 111 includes a storage management module (referred to herein as a “VSAN module”) in order to automate storage management workflows (e.g., create objects in the object store, etc.) and provide access to objects in the object store (e.g., handle I/O operations on objects in the object store, etc.) based on predefined storage policies specified for objects in the object store. For example, because a VM may be initially configured by an administrator to have specific storage requirements (or policy) for its “virtual disk” depending on its intended use (e.g., capacity, availability, performance or input/output operations per second (IOPS), etc.), the administrator may define a storage profile or policy for each VM specifying such availability, capacity, performance and the like. The VSAN module may then create an “object” for the specified virtual disk by backing it with physical storage resources of the object store based on the defined storage policy.

A virtualization management platform 105 is associated with cluster 110 of nodes 111. Virtualization management platform 105 enables an administrator to manage the configuration and spawning of the VMs on the various nodes 111. As illustrated in FIG. 1, each node 111 includes a virtualization layer or hypervisor 113, a VSAN module 114, and hardware 119 (which includes the SSDs 117 and magnetic disks 118 of a node 111). Through hypervisor 113, a node 111 is able to launch and run multiple VMs 112. Hypervisor 113, in part, manages hardware 119 to properly allocate computing resources (e.g., processing power, random access memory, etc.) for each VM 112. Furthermore, each hypervisor 113, through its corresponding VSAN module 114, may provide access to storage resources located in hardware 119 (e.g., SSDs 117 and magnetic disks 118) for use as storage for storage objects, such as virtual disks (or portions thereof) and other related files that may be accessed by any VM 112 residing in any of nodes 111 in cluster 110.

In some examples, VSAN module 114 may be implemented as a “VSAN” device driver within hypervisor 113. In such an embodiment, VSAN module 114 may provide access to a conceptual “VSAN” 115 through which an administrator can create a number of top-level “device” or namespace objects that are backed by object store 116.

One or more nodes 111 of node cluster 110 may be located at a geographical site that is distinct from the geographical site where one or more other nodes 111 are located, such as in the case of a stretched cluster. For example, some nodes 111 of node cluster 110 may be located at building A while other nodes may be located at building B. In another example, the geographical sites may be more remote such that one geographical site is located in one city or country and the other geographical site is located in another city or country. In such examples, any communications (e.g., I/O operations) between a node at one geographical site and a node at the other remote geographical site may be performed through a network, such as a wide area network (“WAN”). Furthermore, as described below, one or more witness nodes may also be included in cluster 110.

While certain aspects are discussed herein with respect to VCIs for a VSAN storing objects associated with the VCIs, the techniques herein are similarly applicable to other types of VCIs associated with other objects, such as iSCSI, container volumes, etc.

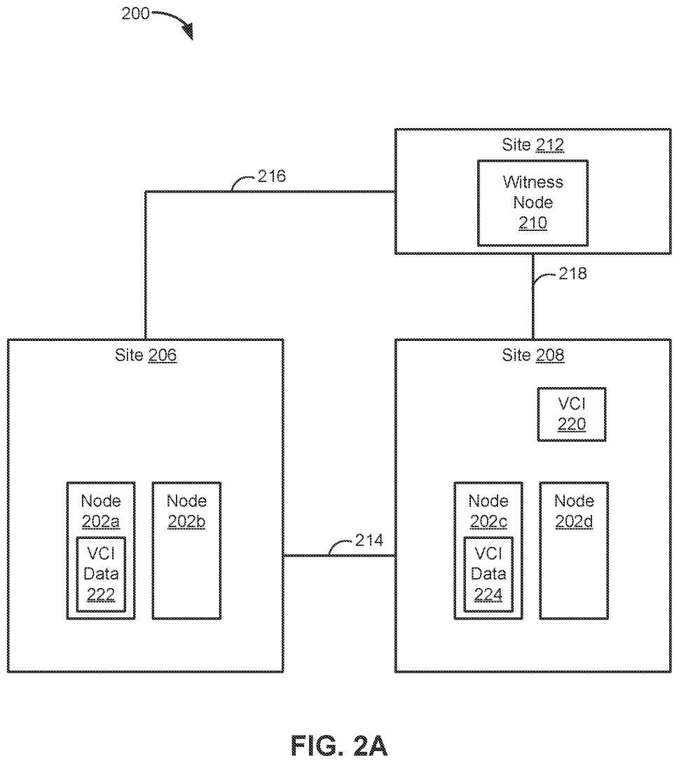

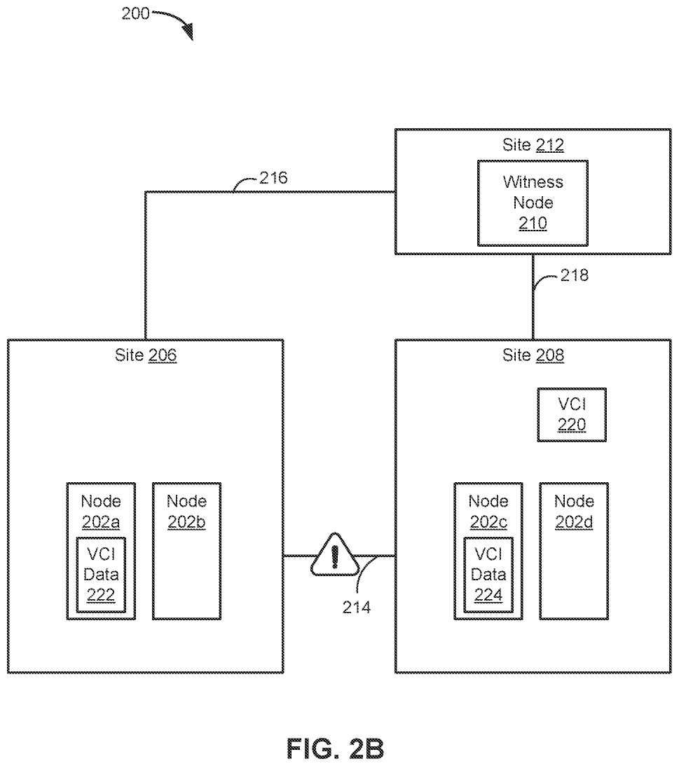

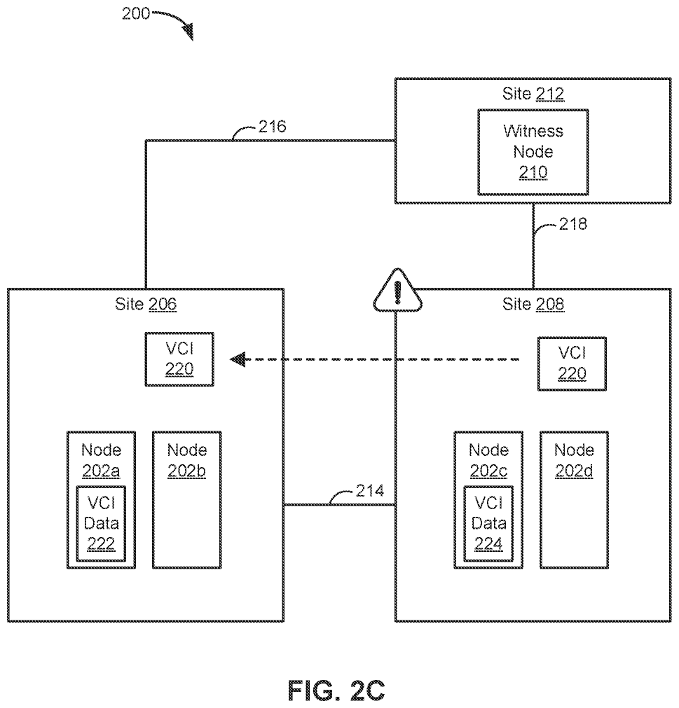

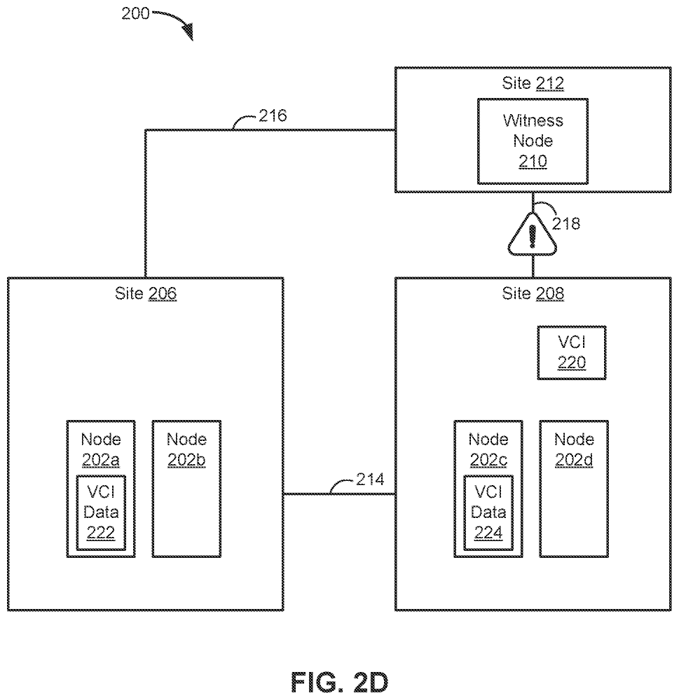

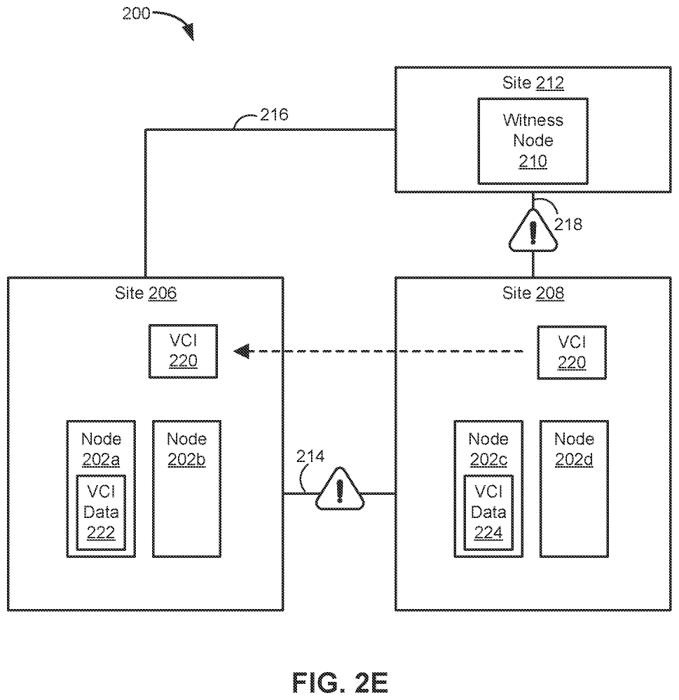

FIGS. 2A-2E illustrates a cluster 200, according to an example embodiment of the present application. The cluster 200 includes nodes 202a, 202b, 202c, and 202d. Nodes 202a-202d may be examples of nodes 111 of FIG. 1. Cluster 200, which may correspond to cluster 110 of FIG. 1, represents a multi-site storage cluster, such as a stretched cluster. A stretched cluster improves data availability by including redundant copies of data across multiple sites in addition to any fault tolerance that may exist within a single site.

In the illustrated example, the cluster 200 includes two sites 206 and 208 and a witness node 210. In the illustrated example, two nodes 202a and 202b are located at the first site 206, two nodes 202c and 202d are located at the second site 208, and the witness node 210 is located at a third site 212. Storage objects (e.g., components of objects) in the cluster 200 are mirrored between the two sites 206 and 208. The sites 206, 208 and 212 may be different physical racks or may be data centers located geographically remote from each other. The sites 206, 208 and 212 are connected via inter-site network links 214, 216, and 218 through, for example, a wide area network (WAN). In the illustrated example, (i) the first site 206 is communicatively coupled to the second site 208 via a first inter-site network link 214, (ii) the first site 206 is communicatively coupled to the third site 212 via a second inter-site network link 216, and (iii) the second site 208 is communicatively coupled to the third site 212 via a third inter-site network link 218.

The witness node 210 represents a computing entity, such as a VCI or physical machine, that provides external observation of the first site 206 and the second site 208 to facilitate determining which sites are available in the event that the sites 206 and 208 become partitioned from one another (e.g., the first inter-site network link 214 fails, etc.). In some examples, the sites 206 and 208 (e.g., a node 202 in each of the sites) and the witness node 210 vote to determine the status of the sites 206 and 208 based on, for example, communicating with each other via the inter-site network links 214, 216, and 218. The majority of the votes determines how the sites 206 and 208 react to a failure. For example, when the sites 206 and 208 are operating and the inter-site network links 214, 216, and 218 are operating, the first site 206 will vote that the first site 206 is operable, the second site 208 will vote that the first site 206 is operable, and the witness node 210 will vote that the first site is operable.

The witness node 210 stores cross-site witness components, which are meta-data components that are dynamically added for objects (or components of objects) with at least dual site mirroring policies (e.g., objects that are mirrored on stretched cluster across at least two sites) and are used to facilitate determining object availability. The witness component associated with a given component or object may indicate a preferred fault domain (and optionally secondary fault domain) for the component, and therefore indicate a preferred fault domain (and optionally secondary fault domain) for a VCI to which the component belongs. In the event of a failure, each site can use its connection to witness node 210 to determine whether to restart VCIs at that site. In some cases, witness node 210 may be a witness appliance. That is, the witness node 210 provides the ability to distinguish between a failure of the first inter-site network link 214 and a failure of one of the sites 206 and 208.

To facilitate detecting a failure of one of the sites 206 and 208, each of the sites 206 and 208 (e.g., a node 202 in each of the sites) sends a heartbeat message to the witness node 210. The heartbeat message may be a packet with a defined payload indicating it is a heartbeat message. For example, each of the sites 206 and 208 sends a heartbeat message to the witness node 210 once every second. When a site fails or when the inter-network link between the site and the witness node 210 fails, the witness node 210 does not receive the heartbeat message and determines that the corresponding site may have failed. For example, if a heartbeat message is not received for a time period, it may be determined that the corresponding site may have failed.

VCIs may operate at the sites 206 and 208. In the illustrated example of FIG. 2A, a VCI 220 operates at the second site 208. For example, the VCI 220 may run on one of node 202c or node 202d. In the illustrated example, because the VCI 220 operates within the stretched cluster 200, the different sites 206 and 208 act as fault domains for the VCI 220. The witness node 210 automatically registers the preferred fault domain of the VCI 220 to be the site in which the VCI is running. In the illustrated example, because the VCI 220 is running (e.g., created) at the second site 208, the witness node 210 automatically registers the preferred fault domain of the VCI 220 to be the second site 208. The secondary fault domain of the VCI 220 may default to the other site 206 (e.g., in a two-site architecture) or may be assigned to the second site 208 by an administrator. A node 202a at the first site 206 and a node 202c at the second site 208 include mirrored copies of storage objects of the VCI 220 (e.g., VCI data 222 and VCI data 224 respectively). In some examples, the witness node 210 stores, in the witness component for each of the VCI data 222 and 224, an indication of the automatically assigned preferred fault domain.

A change in status of communication between the sites 206, 208 and 210 can trigger a determination at the sites 206 and 208 whether to restart VCIs. This change of status can be caused by a failure of the inter-site network link 214, 216, and/or 218 and/or a failure of one of the sites 206, 208, and 210. FIG. 2B illustrates an example of cluster 200 where the inter-site network link 214 between the first site 206 and the second site 208 fails. In such an example, both sites 206 and 208 (e.g., a node 202 in each of the sites) are able to send heartbeat messages to the witness node 210. The sites 206 and 208 (e.g., a node 202 in each of the sites) each determine, in conjunction with the witness node 210, that the other site is available. As such, VCIs (e.g., VCI 220) operating on either of the sites 206 and 208 do not need to restart on the other site because (i) neither site failed and (ii) the VCIs are already operating in their preferred fault domains.

FIG. 2C illustrates an example of cluster 200 where the second site 208 fails. In the illustrated example, the witness node 210 does not receive a heartbeat message from the second site 208 (e.g., a node 202 in the site). From the perspective of the first site 206 (e.g., a node 202 in the site), the scenario illustrated in FIG. 2C appears to be the same as the scenario illustrated in FIG. 2B. That is, to the first site 206, there appears to be a failure of the first inter-site network link 214. However, because witness node 210 does not receive the heartbeat message, the first site 206 determines, in conjunction with the witness node 210, that the second site 208 has failed. In such an example, the first site 206 (e.g., a node 202 in the site) restarts the VCI 220 at the first site 206 (e.g., a node 202 in the site). When the second site 208 is restored, the VCI 220 is stopped at the first site 206 and restarted at the second site 208. Alternatively, in some examples, when the VCI 220 is restarted at the first site 206, the witness node 210 registers the first site 206 as the preferred fault domain of the VCI 220. In such examples, even when the second site 208 is restored, the VCI remains operating at the first site 206.

FIG. 2D illustrates an example of cluster 200 where the third inter-site network link 218 between the second site 208 and the witness node 210 fails. In such an example, the witness node does not receive the heart beat message from the second site 208 (e.g., a node 202 in the site). However, because the first inter-site network link 214 is functional, the first site 206 and the second site 208 (e.g., a node 202 in each of the sites) are able to communicate and determine that neither site 206 and 208 has failed. As such, the VCI 220 remains operating at the second site 208.

FIG. 2E illustrates an example of cluster 200 where the first inter-site network link 214 and the third inter-site network link 218 both fail. In such an example, the witness node does not receive the heart beat message from the second site 208 (e.g., a node 202 in the site). The first site 206 (e.g., a node 202 in the site) determines that the second site 208 has failed in conjunction with the witness node 210. In such an example, the first site 206 (e.g., a node 202 in the site) restarts the VCI 220 at the first site 206 (e.g., a node 202 in the site). Additionally, the second site 208 (e.g., a node 202 in the site) stops the VCI 220 since it is not in communication with the first site 206 or the witness node 210 and will determine that the second site 208 will be adjudged to be experiencing a failure. When the second site 208 is restored, the VCI 220 is stopped at the first site 206 and restarted at the second site 208. Alternatively, in some examples, the witness node 210 registers the first site 206 as the preferred fault domain of the VCI 220. In such examples, even when the second site 208 is restored, the VCI remains operating at the first site 206.

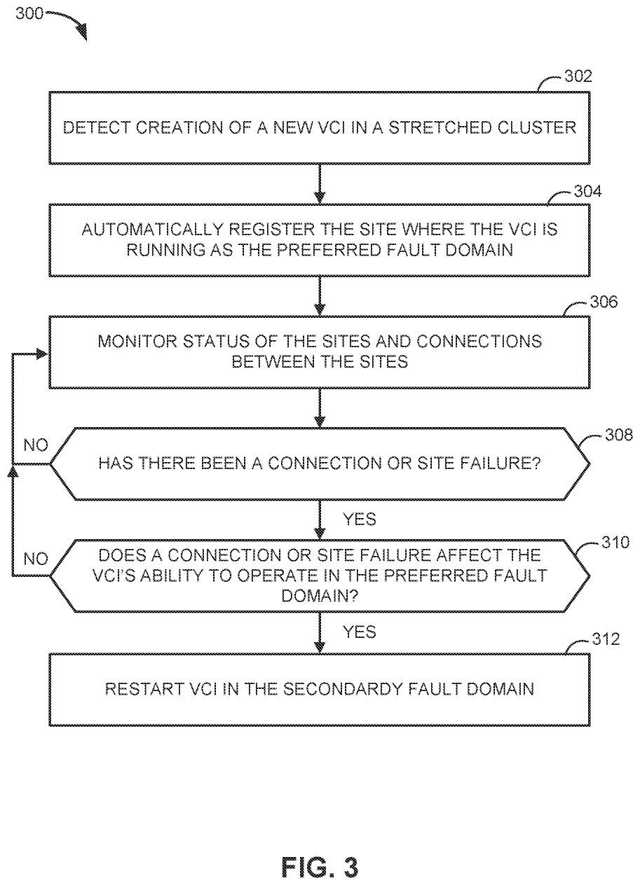

FIG. 3 is a flowchart of example methods to manage faults in a stretched cluster (e.g., stretched cluster 200 of FIGS. 2A-2E). Operations 300 begin at step 302 with detecting, by a witness node (e.g., the witness node 210 of FIGS. 2A-2E), the creation of a new VCI (e.g., the VCI 220 of FIGS. 2A-2E). For example, creation of a new VCI may involve defining a new device object including one or more components for which one or more witness components are generated.

Operations 300 continue at step 304 with automatically registering, by the witness node, the site (e.g., the first site 206 or the second site 208 of FIGS. 2A-2E) where the initially VCI is created to be the preferred fault domain.

Operations 300 continue at step 306 with monitoring, by the sites (e.g., a node in each of the sites) and the witness node, the status of sites (e.g., failed or operation, etc.) and the status of the inter-network links (e.g., the inter-site network links 214, 216, and 218 of FIGS. 2A-2E). For example, the sites (e.g., a node in each of the sites) may send heartbeat messages to the witness node over the respective inter-network links and may send data to each other as part of mirroring the storage objects of the VCI.

Operations 300 continue at step 308 with determining, by the sites, whether there has been a site and/or inter-network link failure. For example, the witness may not receive heartbeat messages from the sites (e.g., a node in each of the sites) and/or the one site (e.g., a node in the site) may not receive communication from the other site (e.g., a node in the site).

When there has been a site and/or inter-network link failure, operations 300 continue at step 310 with determining, by the sites (e.g., a node in each of the sites) whether the failure(s) affect the VCI's ability to operate in its preferred fault domain. For example, the VCI's ability to operate in its preferred fault domain is not affected when the site of the preferred fault domain has not failed and when the failures do not cause the secondary fault domain to determine that the preferred fault domain has failed (e.g., via the witness node).

When the VCI's ability to operate in its preferred fault domain is affected, the operations 300 continue at step 312 with restarting the VCI in the site designated as the secondary fault domain.

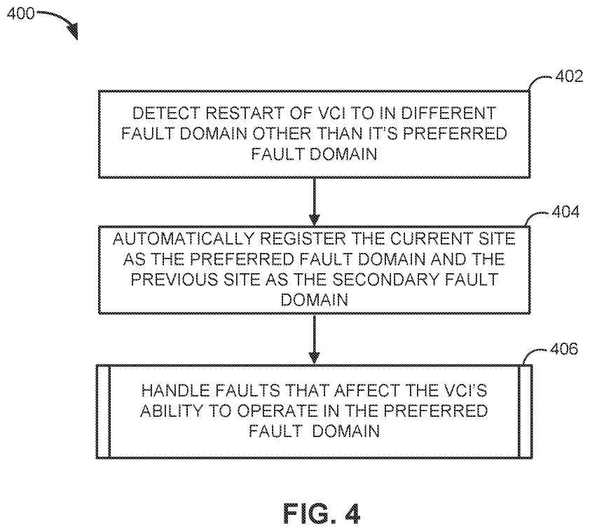

FIG. 4 is a flowchart of example methods to manage faults in a stretched cluster (e.g., stretched cluster 200 of FIGS. 2A-2E). Operations 400 begin at step 402 with detecting, by a witness node (e.g., the witness node 210 of FIGS. 2A-2E), that a VCI (e.g., the VCI 220 of FIGS. 2A-2E) has started or restarted in at a site (e.g., the first site 206 or the second site 208 of FIGS. 2A-2E) other that it's designated preferred fault domain. For example, the witness node may detect a failure or combination of failures that cause the VCI to restart at the site designated as the secondary fault domain. For example, the witness node may detect the VCI has been restarted at step 312 of operations 300 of FIG. 3. As another example, an administrator or a load balancing service may stop the VCI at the first site and restart the VCI at the second site.

Operations 400 continue at step 404 with automatically registering, by the witness node, the current site at which the VCI is operating as the preferred fault domain of the VCI and, optionally in some cases, registering the prior preferred fault domain as the secondary fault domain.

Operations 400 continue at step 406 with handling faults that affect the VCI's ability to operate in the preferred fault domain. An example of handling these faults is described at steps 306-312 of operations 300 of FIG. 3.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method comprising:
detecting a virtual computing instance (VCI) operating on a first node in a first fault domain in a multi-fault domain storage cluster comprising:
the first fault domain comprising the first node,
a second fault domain comprising a second node, and
a witness fault domain comprising a witness node;
automatically registering the first fault domain as a preferred fault domain for the VCI;
determining, at the second fault domain, whether a loss of communication over an inter-fault domain network link between the first fault domain and the second fault domain is due to a failure of the first fault domain or a failure of the inter-fault domain network link; and
in response to the failure of the first fault domain:
restarting, on the second node of the second fault domain, the VCI; and
automatically registering the second fault domain as the preferred fault domain for the VCI.

2. The method of claim 1, further comprising
sending, from the first fault domain and the second fault domain, heartbeat messages to the witness node; and
wherein determining whether the loss of communication over the inter-fault domain network link between the first fault domain and the second fault domain is due to the failure of the first fault domain or the failure of the inter-fault domain network link further comprises receiving an indication from the witness node of whether the first fault domain has sent a heartbeat message to the witness node within a time period.

3. The method of claim 1, further comprising:
detecting a failure of the inter-fault domain network link between the first fault domain and the second fault domain; and
maintaining the VCI at the second fault domain based on the second fault domain being registered as the preferred fault domain for the VCI.

4. The method of claim 1, further comprising:
detecting a loss of communication over a second inter-fault domain network link between the second fault domain and the witness node; and
maintaining the VCI at the second fault domain based on the second fault domain being registered as the preferred fault domain for the VCI.

5. The method of claim 1, further comprising:
detecting a loss of communication over a second inter-fault domain network link between the second fault domain and the witness node and a second occurrence of the loss of communication over the inter-fault domain network link between the first fault domain and the second fault domain;
restarting, in the first fault domain, the VCI; and
automatically registering the first fault domain as the preferred fault domain for the VCI.

6. The method of claim 1, further comprising:
detecting the VCI being restarted at the first fault domain when the second fault domain is operational; and
automatically registering the first fault domain as the preferred fault domain for the VCI.

7. The method of claim 1, wherein the first fault domain comprises a first site, the second fault domain comprises a second site, and the witness fault domain comprises a third site.

8. A multi-fault domain storage cluster comprising:
a first fault domain comprising a first node;
a second fault domain comprising a second node, and
a witness fault domain comprising a witness node;
wherein the witness node is configured to:
detect a virtual computing instance (VCI) operating on the first node;
automatically register the first fault domain as a preferred fault domain for the VCI; and
in response to the VCI restarting on the second node, automatically register the second fault domain as the preferred fault domain for the VCI; and
wherein the second node is configured to:
determine whether a loss of communication over an inter-fault domain network link between the first fault domain and the second fault domain is due to a failure of the first fault domain or a failure of the inter-fault domain network link; and
in response to the failure of the first fault domain, restart the VCI on the second node.

9. The storage cluster of claim 8, wherein:
the first and second fault domains are configured to send heartbeat messages to the witness node; and
to determine whether the loss of communication over the inter-fault domain network link between the first fault domain and the second fault domain is due to the failure of the first fault domain or the failure of the inter-fault domain network link, the second node is configured to receive an indication from the witness node of whether the first fault domain has sent a heartbeat message to the witness node within a time period.

10. The storage cluster of claim 8, wherein the second node is configured to:
detect a failure of the inter-fault domain network link between the first fault domain and the second fault domain; and
maintain the VCI at the second fault domain based on the second fault domain being registered as the preferred fault domain for the VCI.

11. The storage cluster of claim 8, wherein the second node is configured to:
detect a loss of communication over a second inter-fault domain network link between the second fault domain and the witness node; and
maintain the VCI at the second fault domain based on the second fault domain being registered as the preferred fault domain for the VCI.

12. The storage cluster of claim 8, wherein:
the first node is configured to:
detect a loss of communication over a second inter-fault domain network link between the second fault domain and the witness node and a second occurrence of the loss of communication over the inter-fault domain network link between the first fault domain and the second fault domain; and
restart the VCI in the first fault domain; and
the witness node is further configured to automatically register the first fault domain as the preferred fault domain for the VCI.

13. The storage cluster of claim 12, wherein the witness node is configured to:
detect the VCI being restarted at the first fault domain when the second fault domain is operational; and
automatically register the first fault domain as the preferred fault domain for the VCI.

14. The storage cluster of claim 8, wherein the first fault domain comprises a first site, the second fault domain comprises a second site, and the witness fault domain comprises a third site.

15. One or more non-transitory computer-readable media storing instructions that, when executed by processors of a multi-fault domain storage cluster, cause the processors to:
detect a virtual computing instance (VCI) operating on a first node in a first fault domain in the multi-fault domain storage cluster comprising:
the first fault domain comprising the first node,
a second fault domain comprising a second node, and
a witness fault domain comprising a witness node;
automatically register the first fault domain as a preferred fault domain for the VCI;
determine, at the second fault domain, whether a loss of communication over an inter-fault domain network link between the first fault domain and the second fault domain is due to a failure of the first fault domain or a failure of the inter-fault domain network link; and
in response to the failure of the first fault domain:
restart, on the second node of the second fault domain, the VCI; and
automatically register the second fault domain as the preferred fault domain for the VCI.

16. The one or more non-transitory computer-readable media of claim 15, wherein the instructions, when executed, further cause the processors to:
send, from the first fault domain and the second fault domain, heartbeat messages to the witness node; and
wherein to determine whether the loss of communication over the inter-fault domain network link between the first fault domain and the second fault domain is due to the failure of the first fault domain or the failure of the inter-fault domain network link, the instructions, when executed, further cause the processors to receive an indication from the witness node of whether the first fault domain has sent a heartbeat message to the witness node within a time period.

17. The one or more non-transitory computer-readable media of claim 15, wherein the instructions, when executed, further cause the processors to:
detect a failure of the inter-fault domain network link between the first fault domain and the second fault domain; and
maintain the VCI at the second fault domain based on the second fault domain being registered as the preferred fault domain for the VCI.

18. The one or more non-transitory computer-readable media of claim 15, wherein the instructions, when executed, further cause the processors to:
detect a loss of communication over a second inter-fault domain network link between the second fault domain and the witness node; and
maintain the VCI at the second fault domain based on the second fault domain being registered as the preferred fault domain for the VCI.

19. The one or more non-transitory computer-readable media of claim 15, wherein the instructions, when executed, further cause the processors to:
detect a loss of communication over a second inter-fault domain network link between the second fault domain and the witness node and a second occurrence of the loss of communication over the inter-fault domain network link between the first fault domain and the second fault domain;
restart, in the first fault domain, the VCI; and
automatically register the first fault domain as the preferred fault domain for the VCI.

20. The one or more non-transitory computer-readable media of claim 15, wherein the instructions, when executed, further cause the processors to:
detect the VCI being restarted at the first fault domain when the second fault domain is operational; and
automatically register the first fault domain as the preferred fault domain for the VCI.
